(19) United States
(12) Patent Application Publication
(10) Pub. No.: US 2017/0278286 A1
(43) Pub. Date: Sep. 28, 2017

(54) METHOD AND ELECTRONIC DEVICE FOR CREATING TITLE BACKGROUND IN VIDEO FRAME

(71) Applicants: Le Holdings (Beijing) Co., Ltd., Beijing (CN); LE SHI INTERNET INFORMATION & TECHNOLOGY CORP., BEIJING, Beijing (CN)

(72) Inventor: Fengyang AN, Beijing (CN)

(21) Appl. No.: 15/247,125

(22) Filed: Aug. 25, 2016

Related U.S. Application Data
(63) Continuation of application No. PCT/CN2016/089194, filed on Jul. 7, 2016.

(30) Foreign Application Priority Data
Mar. 22, 2016 (CN) 201610166648.5

(51) Int. Cl. G06T 11/60; G06T 7/40; G06T 3/40; G06T 11/00; G06T 7/00; G06T 7/60

(52) U.S. Cl. CPC G06T 11/60; G06T 7/0081; G06T 7/602; G06T 3/40; G06T 11/001; G06T 7/408; G06T 2207/10016; G06T 2207/10024

(57) ABSTRACT

A method for creating a title background in a video frame is disclosed in the present disclosure. The method includes: acquiring image information of the video frame to which a title needs to be added by the video frame processing terminal; converting the image information into a bitmap format; determining a region that is used as the title background in the video frame; capturing a picture corresponding to the region of the title background from the video frame converted into the bitmap format; blurring the captured picture; and overlaying the blurred picture as the title background onto the region of the title background in the video frame.

### CROSS REFERENCE TO RELATED APPLICATIONS

This application is a continuation application of international patent application No. PCT/CN2016/089194, filed on Jul. 7, 2016, which claims priority to Chinese Patent Application No. 201610166648.5, filed with the Chinese Patent Office on Mar. 22, 2016, both of which are herein incorporated by reference in their entireties.

### TECHNICAL FIELD

The present disclosure relates to the field of video playing, and particularly, to a method and an electronic device for creating a title background in a video frame.

### BACKGROUND

In video playing software, usually playable videos are listed to the user by presenting a video frame, and sometimes a title or a logo needs to be added in the frame. Because contents of the video frame are randomly chosen and, for some frames, captions in the video might be captured or the color of the frame to which the title needs to be added is similar to that of the title, the displaying effect of the title is sometimes affected.

The common practice in the related arts is to add a layer of background under the title so that the background is overlaid on the image of the video frame to separate the title and the video flame from each other.

### SUMMARY

A method for creating a title background in a video frame is provided in an embodiment of the present disclosure. The method includes: at an electronic device, acquiring image information of the video frame to which a title needs to be added; converting the image information into a bitmap format; determining a region that is used as the title background in the video frame; capturing a picture corresponding to the region of the title background from the video frame converted into the bitmap format; blurring the captured picture; and overlaying the blurred picture as the title background onto the region of the tide background in the video frame.

An electronic device includes at least one processor and a storage device. The storage device is communicably connected with the at least one processor for storing instructions executable by the at least one processor. Wherein execution of the instructions by the at least one processor causes the at least one processor to:

acquire image information of the video frame to which a title needs to be added by the video frame processing terminal;

convert the image information into a bitmap format;

determine a region that is used as the title background in the video frame;

capture a picture corresponding to the region of the title background from the video frame converted into the bitmap format;

blur the captured picture; and

overlay the blurred picture as the title background onto the region of the title background in the video frame.

A non-transitory computed readable storage medium stores executable instructions. Wherein when the executable instructions are executed by at least one processor causes the at least one processor to:

acquire image information of the video frame to which a title needs to be added by the video frame processing terminal;

convert the image information into a bitmap format; determine a region that is used as the title background in the video frame;

capture a picture corresponding to the region of the title background from the video frame converted into the bitmap format;

blur the captured picture; and

overlay the blurred picture as the title background onto the region of the title background in the video frame.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart diagram of an embodiment of a method for creating a title background in a video frame provided in the present disclosure;

FIG. 2 is a schematic flowchart diagram of another embodiment of a method for creating a title background in a video frame provided in the present disclosure;

FIG. 3 is a schematic diagram of an embodiment of a device for creating a title background in a video frame provided in the present disclosure;

FIG. 4 is a schematic diagram of another embodiment of a device for creating a title background in a video frame provided in the present disclosure;

FIG. 5 is a schematic diagram of an embodiment of a video flame processing terminal provided in the present disclosure.

### DETAILED DESCRIPTION

To make the objective, technical solutions and advantages of the present disclosure clearer, the present disclosure will be further detailed with reference to embodiments thereof and the attached drawings.

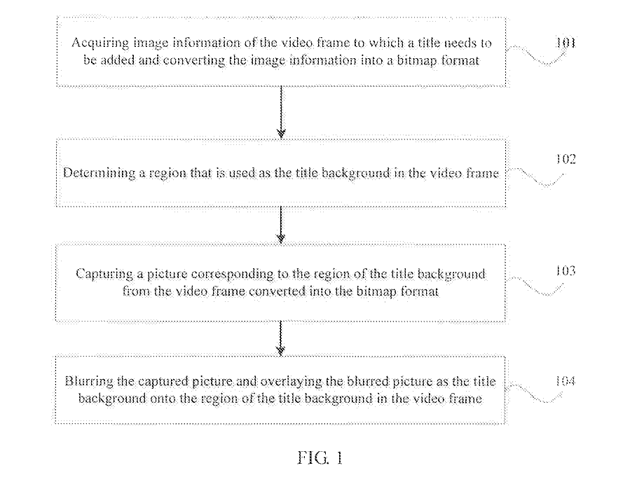

As shown in FIG. 1, an embodiment of a method for creating a title background in a video frame is provided in the present disclosure. The method includes:

In Step 101: acquiring image information of the video frame to which a title needs to be added and converting the image information into a bitmap format.

In the embodiment, acquiring image information of the video frame may be achieved by automatically acquiring an arbitrary frame as the video frame to which a title needs to be added, or it may be set that the user is allowed to set the frame on his own. If the frame is not set by the user, then a default video frame in the system is chosen as the frame to which a title needs to be added.

In Step 102: determining a region that is used as the title background in the video frame.

In the embodiment, a central coordinate of the title background region is set by default in the system, or it may be set that when the user is unsatisfied with the position of the title background, the position of the title background may be changed by changing the central coordinate of the title background region.

In Step 103: capturing a picture corresponding to the region of the title background from the video frame converted into the bitmap format.

In the embodiment, a portion where the region of the title background and the video frame are joined together is blurred after the picture corresponding to the region of the title background is captured.

In Step 104: blurring the captured picture and overlaying the blurred picture as the title background onto the region of the title background in the video frame.

Here, the video frame may be a static picture for demonstration to the user, or be a segment of video for preview, or even be a complete video; the title is not limited to a title in a text form, hut may also be in various other forms such as an icon, a drawing or captions. For example, the text “Pilgrimage to the West” may be added as the title on a picture for video list demonstration of the TV play “Pilgrimage to the West”, the icon of LeTV may be added in a video preview played by the LeTV, or captions are added in the video.

When the embodiment of this method is used to add a title to a dynamic video frame, this method may include: acquiring image information of each video frame and converting the image information into a bitmap format:, capturing a picture corresponding to the region of the title background from each video frame converted into the bitmap format, and blurring the captured picture to obtain the title background of each frame.

The embodiment of the method for creating a title background in a video frame provided in the present disclosure extracts, as an input of the blurring operation, an image sample of a partial frame from a video frame corresponding to the title, blurs the image sample through blurring calculations according to appropriate blurring parameters, and then overlays the title background onto a corresponding position in the frame. In this way, characters and objects originally present in the corresponding video frame under the title can be scattered in a proper way so that they will not affect displaying of the title (i.e., the displaying object), and as a part of the video frame, the title background will not affect the displaying effect of the frame either.

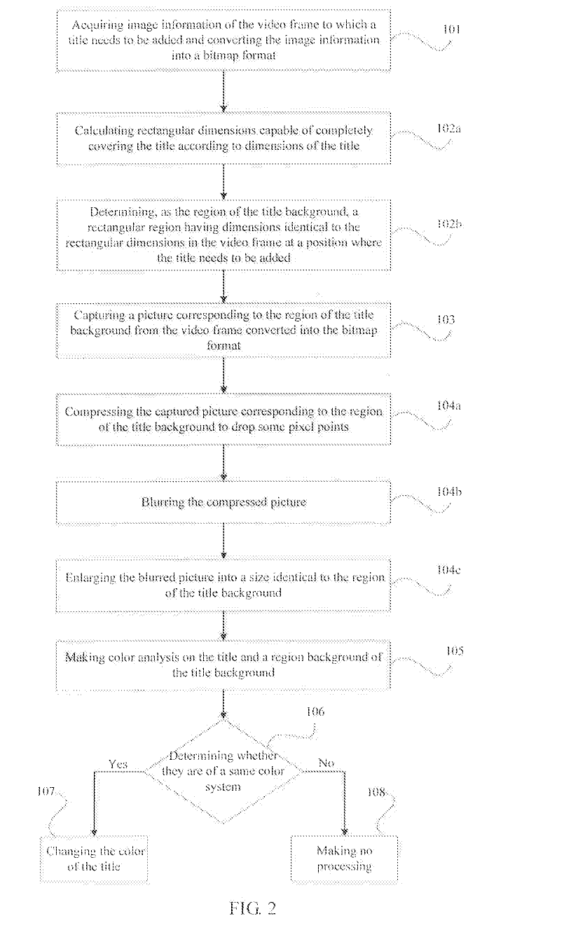

Further, as shown in FIG. 2, step 102 of determining a region that is used as the title background in the video frame is as follows:

in Step 102a: calculating rectangular dimensions capable of completely covering the title according to dimensions of the title.

In the embodiment, the rectangular dimensions capable of completely covering the title are calculated to be minimum dimensions capable of completely covering the title.

In Step 102b: determining, as the region of the title background, a rectangular region having dimensions identical to the rectangular dimensions in the video frame at a position where the title needs to be added.

In the embodiment, a central coordinate of the determined region of the title background is taken as the position where the title is to be added and, by taking this central coordinate as a central point, a rectangular region having dimensions identical to the rectangular dimensions is determined as the region of the title background.

In some embodiments, step 104 of blurring the captured picture is as follows:

In Step 104a: compressing the captured picture corresponding to the region of the title background to drop some pixel points.

In Step 104b: blurring the compressed picture.

In Step 104c: enlarging the blurred picture into a size identical to the region of the title background.

The blurring is achieved by taking an average value of surrounding pixels that surround the central pixel within a certain radius, and during the averaging process, weights are calculated according to a normal distribution to obtain a weighted average value. The captured picture corresponding to the region of the title background is compressed to a certain extent so that some pixel points are dropped. Reduction in the number of the pixel points leads to reduction in the number of pixel points located within a same radius from the central pixel point. Finally, the compressed picture is blurred. Because the number of pixel points involved in calculation of the average value is reduced, the calculation efficiency is increased. Enlarging the blurred picture into a size identical to the region of the title background allows for seamless joining of the title background with the video frame, so the displaying effect of the title background becomes more appealing.

In another embodiment ref the present disclosure as shown in FIG. 2, the method for creating a title background in a video frame includes:

In Step 101: automatically acquiring an arbitrary video frame as image information of a video frame to which a title needs to be added, and converting the image information into a bitmap format.

In Step 102a: calculating rectangular dimensions capable of completely covering the title according to dimensions of the title.

In Step 102b: determining, as the region of the title background, a rectangular region corresponding to the rectangular dimensions in the video frame at a position where the title needs to be added.

In the embodiment, a central coordinate of the region of the title background is set by default in the system, for example, the central coordinate of the video frame is taken as the central coordinate of the region of the title background. Then the central coordinate of the region of the title background is taken as a position where the title is to be added, and by taking the central coordinate as a central point, a rectangular region having dimensions identical to the rectangular dimensions is determined as the region of the title background.

In Step 103: capturing a picture corresponding to the region of the title background from the video frame converted into the bitmap format.

In Step 104a: compressing the captured picture corresponding to the region of the title background to drop some pixel points.

In the embodiment, step 104a of compressing the captured picture corresponding to the region of the title background to drop some pixel points is achieved by: compressing the picture corresponding to the region of the title background at an equal proportion according to a preset compression ratio to obtain a low-pixel-number picture. The purpose of compressing at an equal proportion is to prevent image distortion after the picture is compressed, which would otherwise affect the displaying effect.

In Step 104b: blurring the compressed picture.

In the embodiment, the Gaussian blurring algorithm is adopted to blur the compressed picture.

In Step 104c: enlarging the blurred picture into a size identical to the region of the title background.

In Step 105: making color analysis on the title and a region background of the title background.

In the embodiment, five color systems of the black color, the white color, the red color, the green color and the blue color are set and five corresponding color thresholds are correspondingly set to analyze the color of each pixel point. Pixel points within a threshold range are determined to be of a color system corresponding to the threshold range.

In Step 106: determining whether the color of the title and the color of the region background of the title background are of a same color system.

In Step 107: changing the color of the title if the color of the title and the color of the region background of the title background are of a same color system, and otherwise, turning to Step 108: making no processing. For example, if both the title and the region background of the title background are of the red color system, then the color of the title may be changed into the green color system or the blue color system that is in contrast with the red color system to prevent unclearness of the title.

When the title and the background region are composed of more than one color systems, comparison in color is made on regions where the title is adjacent to the background region to determine whether the title and the background region are of a same color system in the adjacent regions. If they are, then the color of the corresponding region of the title background is changed, and otherwise, no processing will be made.

The embodiment of the method for creating a title background in a video frame provided in the present disclosure extracts an image sample of a partial image in the video frame corresponding to the title, blurs the image sample and then overlays the blurred image sample as a title background onto a corresponding position in the frame. In this way, characters and objects originally present in the corresponding video frame under the title can be scattered in a proper way so that they will not affect displaying of the title, and as a part of the video frame, the title background will not affect the displaying effect of the frame either. Meanwhile, by compressing the captured picture corresponding to the region of the title background to drop some pixel points, the number of pixel points involved in the blurring calculation process is reduced and, therefore, the calculation efficiency is significantly improved.

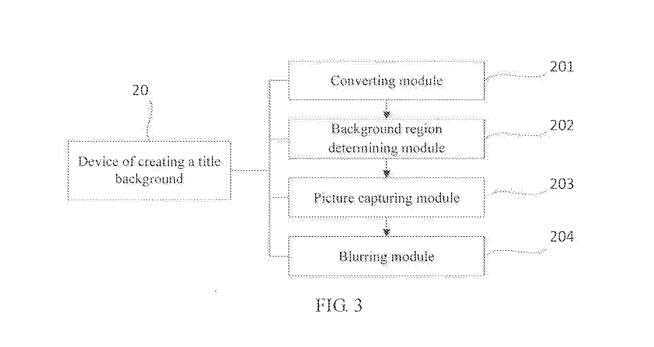

On the other hand, an embodiment of the present disclosure also provides a device 20 for creating a title background in a video frame as shown in FIG. 3, which includes: a converting module 201, a background region determining module 202, a picture capturing module 203, and a blurring module 204.

The converting module 201 is configured to acquire image information of the video frame to which a title needs to be added and convert the image information into a bitmap format.

In the embodiment, the converting module 201 automatically acquires an arbitrary frame as the video frame to which a title needs to be added.

The background region determining module 202 is configured to determine a region that is used as the title background in the video frame.

The picture capturing module 203 is configured to capture a picture corresponding to the region of the title background from the video frame converted into the bitmap format.

The blurring module 204 is configured to blur the captured picture and overlay the blurred picture as the title background onto the region of the title background in the video frame.

By extracting an image sample of a partial frame from a video frame corresponding to the title, blurring the image sample through blurring calculations according to appropriate blurring parameters, and then overlaying the blurred image sample as the title background onto a corresponding position in the frame, characters and objects originally present in the corresponding video frame under the title can be scattered in a proper way so that they will not affect displaying of the title (i.e., the displaying object), and as a part of the video frame, the title background will not affect the displaying effect of the frame either.

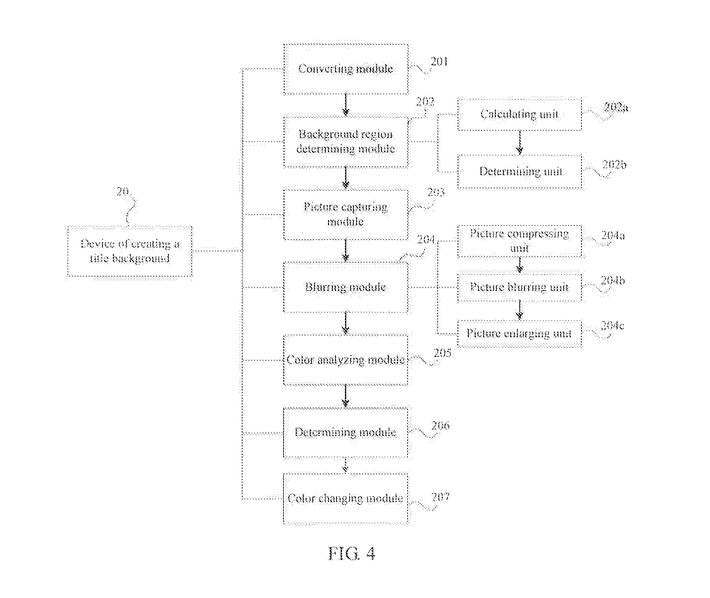

Further, as shown in FIG. 4, the blurring module 204 includes: a picture compressing unit 204a, a picture blurring unit 204b, and a picture enlarging unit 204c.

The picture compressing unit 204a is configured to compress the captured picture corresponding to the region of the title background to drop some pixel points.

The picture blurring unit 204b is configured to blur the compressed picture.

The picture enlarging unit 204c is configured to enlarge the blurred picture into a size identical to the region of the title background.

The picture compressing unit 204a is further configured to compress the picture corresponding to the region of the title background at an equal proportion according to a preset compression ratio to obtain a low-pixel-number picture. The purpose of compressing at an equal proportion is to prevent image distortion after the picture is compressed, which would otherwise affect the displaying effect.

The picture blurring unit 204b is further configured to adopt the Gaussian blurring algorithm to blur the compressed picture.

The blurring is achieved by taking an average value of surrounding pixels that surround the central pixel within a certain radius, and during the averaging process, weights are calculated according to a normal distribution to obtain a weighted average value. The picture compressing unit 204a compresses the captured picture corresponding to the region of the title background to drop some pixel points. Reduction in the number of the pixel points leads to reduction in the number of pixel points located within a same radius from the central pixel point. Finally, the picture blurring unit 204b blurs the compressed picture. Because the number of pixel points involved in calculation of the average value is reduced, the calculation efficiency is increased. The picture enlarging unit 204c enlarges the blurred picture into a size identical to the region of the title background allows for seamless joining of the title background with the video frame, so the displaying effect of the title background becomes more appealing.

Further, the background region determining module 202 includes: a calculating unit 202a and a determining unit 202b.

The calculating unit 202a is configured to calculate rectangular dimensions capable of completely covering the title according to dimensions of the title.

The determining unit 202b is configured to determine, as the region of the title background, a rectangular region having dimensions identical to the rectangular dimensions in the video frame at a position where the title needs to be added.

The device 20 for creating a title background in a video frame further includes: a color analyzing module 205, a determining module 206, and a color changing module 207.

The color analyzing module 205 is configured to make color analysis on the title and a region background of the title background.

The determining module 206 is configured to determine whether a color of the, title and a color of the region background of the title background are of a same color system.

The color changing module 207 is configured to change the color of the title if the color of the title and the color of the region background of the title background are of a same color system.

In some embodiments, if the analysis reveals that both the title and the background of the region of the title background are of the red color system, then the color of the title may be changed into the green color system or the blue color system to prevent unclearness of the title.

In the device 20 for creating a title background in a video frame provided in the embodiments of the present disclosure, the picture capturing module 203 extracts an image sample of a partial image in the video frame corresponding to the title, the blurring module 204 blurs the image sample and then overlays the blurred image sample as a title background onto a corresponding position in the frame. In this way, characters and objects originally present in the corresponding video frame under the title can be scattered in a proper way so that they will not affect displaying of the title, and as a part of the video frame, the title background will not affect the displaying effect of the frame either. Meanwhile, the picture compressing unit 204a compresses the captured picture corresponding to the region of the title background to drop some pixel points, so the number of pixel points involved in the blurring calculation process is reduced and, therefore, the calculation efficiency is significantly improved.

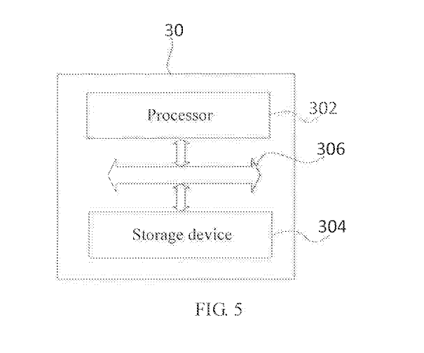

As shown in FIG. 5, an embodiment of a video frame processing terminal 30 provided in the present disclosure includes: at least one processor 302, a storage device 304, and a bus system 306. The at least one processor 302 and the storage device 304 are connected to each other via the bus system 306, the storage device 304 is configured to store program instructions, and the at least one processor 302 is caused to execute the program instructions stored in the storage device 304.

The storage device 304 may be a non-transitory computed readable storage medium, which is configured to store computed executable program instructions. When the program instructions are executed by one or more central processors, for example, the processor 302 may be caused to perform the steps in the above mentioned embodiments of the method, for example, steps 101 to 104 illustrated in FIG. 1, steps 101 to 108 illustrated in FIG. 2. The computed executable program instructions may also be stored and/or transmitted in any non-transitory computed readable storage medium, such that these program instructions are used by an instruction executing system, apparatus or device, or used in combination with the instruction executing system, apparatus or device. The instruction executing system, apparatus or device may be, for example, a computer-based system, a system including a processor or another system capable of acquiring program instructions from the instruction executing system, apparatus or device and executing the program instructions. For the purpose of this specification, the “non-transitory computed readable storage medium” may be any tangible medium including or storing computed executable program instructions. The computed executable program instructions may be used by the instruction executing system, apparatus or device, or used in combination with the executing system, apparatus or device. The non-transitory computed readable storage medium may include, but not limited to, a magnetic, optical and/or semiconductor storage device. Examples of these storage devices include a magnetic disk, an optical disc based on CD, DVD and Blu-ray technology, and permanent solid memory (for example, a flash memory, a solid driver and the like).

In some embodiments, the device 20 of FIG. 3, as mentioned above, may be a computed software program device, the modules 201-204 are computed software program modules, stored in the storage device 304, and executed by the processor 302 to achieve the function of each module when in working. Similarly, the units 202a, 202b, 204a, 204b, 204c and the modules 205, 206, 207 are also computed software program modules, stored in the storage device 304, and executed by the processor 302 to achieve the function of each module when in working.

It should be understood that in the embodiments of the present application, the processor 302 may be a central processing unit (CPU). The processor 302 may be a general processor, a digital signal processor (DSP), an application specific integrated circuit (ASIC), a field programmable gate array (FPGA) or another programmable logic device, a discrete gate or transistor logic device, or a discrete hardware component. The general processor may be a microprocessor or any customary processor or the like.

In addition to a data bus, the bus system 306 may further includes a power bus, a control bus, a state signal bus and the like. However, for clarity of description, various buses are all marked as the bus system 306.

In the embodiments of the present invention, the video frame processing terminal 30 is not limited to the components and configurations as illustrated in FIG. 5, but may further include other or additional components having a plurality of configurations.

During the implementation, various steps in the above method and various modules and units in the above device may be implemented by means of an integrated logic circuit in the processor 302 or by means of software. The steps in the method and the modules and units in the device disclosed in the embodiments of the present invention may be directly embodied as being implemented by a hardware processor, or implemented by a combination of hardware in the processor and other software modules. The software module may be located in a random memory, a flash memory, a read-only: memory, a programmable read-only memory, an electrically erasable programmable memory, a register or the like storage medium commonly known in the art. The storage medium is located in the storage device 304. The processor 302 reads the information stored in the storage device 304 and performs the steps of the above method in combination with the hardware thereof. For brevity of description, the details are not given herein any further.

As shall be appreciated by those of ordinary skill in the art, the above discussion of any embodiments is only illustrative and is not intended to imply that the scope (including the claims) of the present disclosure is limited to these examples; and within the spirits of the present disclosure, technical features of the above embodiments or different embodiments may be combined with each other, the steps may be achieved in any sequence, and there are many other variations in different aspects of the present disclosure described above, although they are not detailed for purpose of simplicity.

Embodiments of the present disclosure are intended to cover ail such replacements, modifications and variations falling within the broad scope of die attached claims. Accordingly, any omissions, modifications, equivalent replacements, and alterations within the spirits and principles of the present disclosure shall be included in the scope of the present disclosure.

What is claimed is:

1. A method for creating a title background in a video frame, comprising:
at an electronic device;
acquiring image information of the video frame to which a title needs to be added;
converting the image information into a bitmap format;
determining a region that is used as the title background in the video frame;
capturing a picture corresponding to the region of the title background from the video frame converted into the bitmap format;
blurring the captured picture; and
overlaying the blurred picture as the title background onto the region of the title background in the video frame.

2. The method for creating a title background according to claim 1, wherein blurring the captured picture comprises;
compressing the captured picture corresponding to the region of the title background to drop some pixel points;
blurring the compressed picture; and
enlarging the blurred picture into a size identical to the region of the title background.

3. The method for creating a title background according to claim 2, wherein determining a region that is used as the title background in the video flame comprises:
calculating rectangular dimensions capable of completely covering the title according to dimensions of the title; and
determining, as the region of the title background, a rectangular region corresponding to the rectangular dimensions in the video frame at a position where the title needs to be added.

4. The method for creating a title background according to claim 2, wherein the method further comprises:
making color analysis on the title and a region background of the title background;
determining whether a color of the title and a color of the region background of the title background are of a same color system; and
changing the color of the title if the determination result is yes.

5. The method for creating a title background according to claim 2, wherein compressing the captured picture corresponding to the region of the title background to drop some pixel points comprises: compressing the picture corresponding to the region of the title background at an equal proportion according to a preset compression ratio to obtain a low-pixel-number picture.

6. The method for creating a title background according to claim 2, wherein blurring the compressed picture comprises: adopting the Gaussian blurring algorithm to blur the compressed picture.

7. An electronic device, comprising:
at least one processor; and
a storage device communicably connected with the at least one processor for storing instructions executable by the at least one processor, wherein execution of the instructions by the at least one processor causes the at least one processor to:
acquire image information of the video frame to which a title needs to be added by the video frame processing terminal;
convert the image information into a bitmap format;
determine a region that is used as the title background in the video frame;
capture a picture corresponding to the region of the title background from the video frame converted into the bitmap format;
blur the captured picture; and
overlay the blurred picture as the title background onto the region of the title background in the video frame.

8. The electronic device according to claim 7, wherein blurring the captured picture comprises:
compressing the captured picture corresponding to the region of the title background to drop some pixel points;
blurring the compressed picture; and
enlarging the blurred picture into a size identical to the region of the title background.

9. The electronic device according to claim 8, wherein determining a region that is used as the title background in the video frame comprises:
calculating rectangular dimensions capable of completely covering the title according to dimensions of the title; and
determining, as the region of the title background, a rectangular region corresponding to the rectangular dimensions in the video frame at a position where the title needs to be added.

10. The electronic device according to claim 8, wherein execution of the instructions by the at least one processor further causes the at least one processor to:
make color analysis on the title and a region background of the title background;
determine whether a color of the title and a color of the region background of the title background are of a same color system; and
change the color of the title if the determination result is yes.

11. The electronic device according to claim 8, wherein compressing the captured picture corresponding to the region of the title background to drop some pixel points comprises: compressing the picture corresponding to the region of the title background at an equal proportion according to a preset compression ratio to obtain a low-pixel-number picture.

12. The electronic device according to claim 8, wherein blurring the compressed picture comprises; adopting the Gaussian blurring algorithm to blur the compressed picture.

13. A non-transitory computed readable storage medium storing executable instructions, wherein when the executable instructions are executed by at least one processor causes the at least one processor to:
acquire image information of the video frame to which a title needs to be added by the video frame processing terminal;
convert the image information into a bitmap format;
determine a region that is used as the title background in the video frame;
capture a picture corresponding to the region of the title background from the video frame converted into the bitmap format;
blur the captured picture; and
overlay the blurred picture as the title background onto the region of the title background in the video frame.

14. The non-transitory computed readable storage medium according to claim 13, wherein blurring the captured picture comprises:
compressing the captured picture corresponding to the region of the title background to drop some pixel points;
blurring the compressed picture; and
enlarging the blurred picture into a size identical to the region of the title background.

15. The non-transitory computed readable storage medium according to claim 14, wherein determining a region that is used as the title background in the video frame comprises:
calculating rectangular dimensions capable of completely covering the title according to dimensions of the title; and
determining, as the region of the title background, a rectangular region corresponding to the rectangular dimensions in the video frame at a position where the title needs to be added.

16. The non-transitory computed readable storage medium according to claim 14, wherein when the executable instructions are executed by the at least one processor further causes the at least one processor to:
make color analysis on the title and a region background of the title background;
determine whether a color of the title and a color of the region background of the title background are of a same color system; and
change the color of the title if the determination result is yes.

17. The non-transitory computed readable storage medium according to claim 14, wherein compressing the captured picture corresponding to the region of the title background to drop some pixel points comprises: compressing the picture corresponding to the region of the title background at an equal proportion according to a preset compression ratio to obtain a low-pixel-number picture.

18. The non-transitory computed readable storage medium according to claim 14, wherein blurring the compressed picture comprises: adopting the Gaussian blurring algorithm to blur the compressed picture.
